(19) United States
(12) Patent Application Publication
(10) Pub. No.: US 2026/0167017 A1
(43) Pub. Date: Jun. 18, 2026

(54) PROCESSING APPARATUS FOR ELECTRIC VEHICLE

(71) Applicant: SUBARU CORPORATION, Tokyo (JP)

(72) Inventor: Shunsuke FUKUTOMI, Tokyo (JP)

(21) Appl. No.: 19/531,199

(22) Filed: Feb. 5, 2026

Related U.S. Application Data
(63) Continuation of application No. PCT/JP2023/033781, filed on Sep. 15, 2023.

(51) Int. Cl. B60L 15/20; B60L 58/16; G07C 5/08

(52) U.S. Cl. CPC B60L 15/20; B60L 58/16; G07C 5/0825; B60L 2250/16

(57) ABSTRACT

A processing apparatus to be applied to an electric vehicle includes a vehicle processor and a battery processor. The vehicle processor is configured to control driving of a travel motor of the electric vehicle to cause an output of a battery of the electric vehicle to become less than or equal to an output upper limit of the battery. The battery processor is configured to monitor a state of the battery. The vehicle processor is configured to operate in a control mode including a boost mode. The boost mode is designed to temporarily raise the output upper limit in response to an operation of a boost operation member of the electric vehicle. The vehicle processor is configured to determine whether to permit the boost mode, based on a degradation state amount of the battery.

### CROSS-REFERENCE TO RELATED APPLICATIONS

This application is continuation of International Application No. PCT/JP2023/033781, filed on Sep. 15, 2023, the entire contents of which are hereby incorporated by reference.

### BACKGROUND

The disclosure relates to a processing apparatus for an electric vehicle.

Japanese Unexamined Patent Application Publication No. 2022-092106 discloses an electric vehicle provided with a system including a first travel mode in which an output upper limit of a battery is set to a reference value and a second travel mode in which the output upper limit of the battery is set to a value higher than the reference value. The system switches a travel mode to the second travel mode in response to a request from a driver who drives the electric vehicle.

### SUMMARY

An aspect of the disclosure provides a processing apparatus to be applied to an electric vehicle. The electric vehicle includes a travel motor configured to drive a drive wheel, a battery configured to store electric power usable for traveling of the electric vehicle, a boost operation member configured to be operated by a driver who drives the electric vehicle, and a display to be disposed in a driver's cabin of the electric vehicle. The processing apparatus includes a vehicle processor and a battery processor. The vehicle processor is configured to control driving of the travel motor to cause an output of the battery to become less than or equal to an output upper limit of the battery. The battery processor is configured to monitor a state of the battery. The vehicle processor is configured to operate in a control mode including a boost mode. The boost mode is designed to temporarily raise the output upper limit in response to an operation of the boost operation member. The vehicle processor is configured to determine whether to permit the boost mode, based on a degradation state amount of the battery. The vehicle processor is configured to output a gauge indication to the display when the boost mode is determined not to be permitted based on the degradation state amount. The gauge indication indicates how much change in the degradation state amount is necessary to permit the boost mode. The degradation state amount includes a difference between an assumed degradation degree planned in advance and a degradation degree of the battery estimated by the battery processor.

An aspect of the disclosure provides a processing apparatus to be applied to an electric vehicle. The electric vehicle includes a travel motor configured to drive a drive wheel, a battery configured to store electric power usable for traveling of the electric vehicle, a boost operation member configured to be operated by a driver who drives the electric vehicle, and a display to be disposed in a driver's cabin of the electric vehicle. The processing apparatus includes a vehicle processor and a battery processor. The vehicle processor is configured to control driving of the travel motor to cause an output of the battery to become less than or equal to an output upper limit of the battery. The battery processor is configured to monitor a state of the battery. The vehicle processor is operatable in a control mode including a boost mode. The boost mode is configured to temporarily raise the output upper limit in response to an operation of the boost operation member. The vehicle processor is configured to determine whether to permit the boost mode, based on a degradation state amount of the battery. The vehicle processor is configured to output a gauge indication to the display when the boost mode is determined not to be permitted based on the degradation state amount. The gauge indication indicates how much change in the degradation state amount is necessary to permit the boost mode. The vehicle processor is further configured to output an information indication to the display when the boost mode is determined not to be permitted based on the degradation state amount. The information indication indicates a travel method that allows faster transition of the control mode to the boost mode.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an electric vehicle equipped with a processing apparatus according to one example embodiment of the disclosure.

FIG. 2 is a flowchart illustrating boost mode control processing executed by a vehicle processor illustrated in FIG. 1.

FIG. 3A is an explanatory graph of a degradation state amount of a battery calculated to determine whether to permit a boost mode.

FIG. 3B is a diagram illustrating an exemplary image displayed on a display in a case of a degradation state illustrated in FIG. 3A.

FIG. 4A is another explanatory graph of the degradation state amount of the battery calculated to determine whether to permit the boost mode.

FIG. 4B is a diagram illustrating an exemplary image displayed on the display in a case of a degradation state illustrated in FIG. 4A.

### DETAILED DESCRIPTION

A lifetime of a battery of an electric vehicle can be extended by keeping an output upper limit of the battery to a low value. Meanwhile, a preference of a driver who drives the electric vehicle can be satisfied by activating a boost mode that temporarily permits a large output. The boost mode, however, involves a time interval between its first activation and its second activation. In such a situation where the boost mode is difficult to activate, it is desired that the driver grasp how soon the boost mode is to become activatable.

It is desirable to provide a processing apparatus for an electric vehicle that performs a boost mode operation highly usable by a driver who drives the electric vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

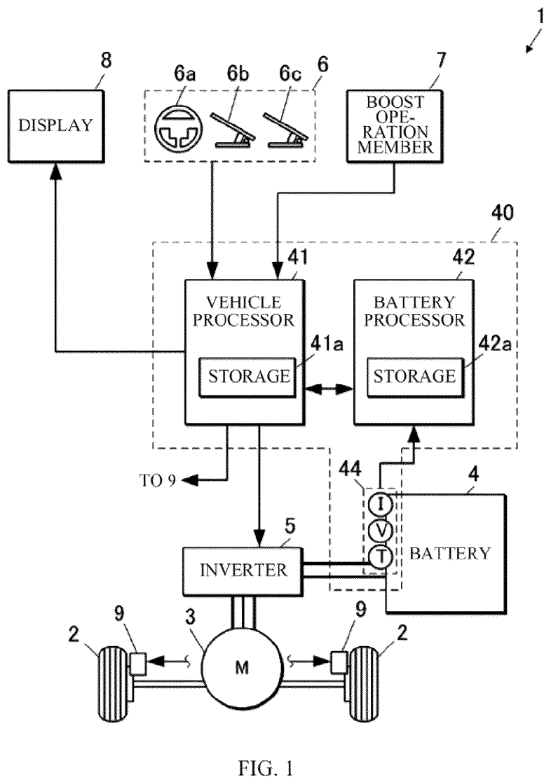

FIG. 1 is a block diagram illustrating an electric vehicle equipped with a processing apparatus according to one example embodiment of the disclosure.

An electric vehicle 1 includes drive wheels 2, a travel motor 3, a battery 4, an inverter 5, a travel operation unit 6, a boost operation member 7, a display 8, a braking device 9, and a processing apparatus 40 according to the present example embodiment. The travel motor 3 drives the drive wheels 2. The battery 4 stores electric power usable for traveling of the electric vehicle 1. The inverter 5 may convert the electric power between the battery 4 and the travel motor 3. The travel operation unit 6 may be configured to operate traveling of the electric vehicle 1. The boost operation member 7 is configured to be operated by a driver who drives the electric vehicle 1. The display 8 is disposed in a driver's cabin. The braking device 9 may produce braking action by pressure such as hydraulic pressure. The processing apparatus 40 may control the electric vehicle 1.

The travel operation unit 6 may include a steering operation member 6a such as a steering wheel, an accelerator operation member 6b such as an accelerator pedal, and a brake operation member 6c such as a brake pedal. In some embodiments, the travel operation unit 6 may be operated by the driver or an automated driving system.

The boost operation member 7 may activate a boost mode. In the present example embodiment, the boost operation member 7 may be any operation member such as a push button, a paddle, or an operation member on a touch panel; however, various other kinds of operation members may be adopted for the boost operation member 7. In some embodiments, the travel operation unit 6 such as the accelerator operation member 6b may serve also as the boost operation member 7, and an operation performed by the travel operation unit 6 in accordance with a predetermined method may be recognized as an operation of the boost operation member 7, i.e., an operation that activates the boost mode. Various operations performed in accordance with various methods may be recognized as the operation that activates the boost mode. In some embodiments, an operation of setting a depression speed to Z or higher when a depression amount of the accelerator pedal is within a range Y may be recognized as the operation that activates the boost mode.

In the present example embodiment, the travel motor 3 may be any motor such as an electric motor. The battery 4 may supply electric power usable for driving the travel motor 3. In the present example embodiment, the battery 4 may be any battery such as a lithium-ion secondary battery or a nickel-hydrogen secondary battery; however, the kind of the battery 4 is not particularly limited. The battery 4 may store electric power supplied from an external power source and regenerative power transmitted from the travel motor 3. The inverter 5 may cause the travel motor 3 to perform a power running operation by transmitting the electric power of the battery 4 to the travel motor 3 and to perform a regenerative operation by transmitting the regenerative power of the travel motor 3 to the battery 4.

The processing apparatus 40 includes a vehicle processor 41 and a battery processor 42. The vehicle processor 41 may control traveling of the electric vehicle 1 and control a user interface via the display 8. The battery processor 42 may manage the battery 4. In the present example embodiment, the vehicle processor 41 and the battery processor 42 may be each a microcomputer that operates in accordance with a control program. The vehicle processor 41 and the battery processor 42 may operate in conjunction with each other by communicating with each other.

The processing apparatus 40 may further include a sensor 44 that measures a current, a voltage, and a temperature of the battery 4. The sensor 44 may transmit a measurement signal to the battery processor 42.

In some embodiments, the microcomputers included in the processing apparatus 40 may not be separately provided as the vehicle processor 41 and the battery processor 42 and may be provided as a single microcomputer in which the vehicle processor 41 and the battery processor 42 are integrated. In some embodiments, the processing apparatus 40 may include three or more microcomputers, and achieve respective operations of the vehicle processor 41 and the battery processor 42 by causing the three or more microcomputers to operate in conjunction with each other.

The vehicle processor 41 may receive respective operation signals of the travel operation unit 6 and the boost operation member 7. In accordance with the respective operations of the travel operation unit 6 and the boost operation member 7 and a state of the battery 4, the vehicle processor 41 may control the inverter 5 and the braking device 9 to thereby control a driving force and a braking force of the electric vehicle 1.

The battery processor 42 may measure or estimate the state of the battery 4, based on the measurement signal of the sensor 44, and monitor the state of the battery 4. The term “state of the battery 4” may encompass charge remains such as a state of charge (SOC) and a degradation degree such as a state of health (SOH).

In some embodiments, the battery processor 42 may calculate SOCs at respective time points by accumulating electric current values obtained at the respective time points or making conversion from voltage values obtained at the respective time points. In some embodiments, the battery processor 42 may calculate a full charge capacity of the battery 4 by detecting a full charge state and a predetermined discharge state of the battery 4, based on constantly accumulated electric current values and constantly measured voltage values, and calculate the SOH by comparing the calculated full charge capacity with an initial full charge capacity of the battery 4. The term “SOH” used herein may refer to a percentage of a full charge capacity at the time of degradation of the battery 4 to the initial full charge capacity, provided that the initial full charge capacity is defined as 100%. In some embodiments, the battery processor 42 may store, in a storage 42a, a calculation expression or data table indicating a relationship between various state amounts of the battery 4 and estimated values of the SOH, and estimate the SOH, based on measured values of the respective state amounts using the calculation expression or the data table. Non-limiting examples of the state amounts of the battery 4 related to the SOH at the time of traveling of the electric vehicle 1 may include a charging and discharging rate of the battery 4 (also referred to as a “C rate”), a temperature of the battery 4, and a range of the SOC of the battery 4 having been subjected to charging and discharging. Non-limiting examples of the state amounts of the battery 4 related to the SOH at the time of stopping of the electric vehicle 1 may include the SOC of the battery 4 and the temperature of the battery 4.

Note that the degradation degree of the battery 4 to be managed by the battery processor 42 is not limited to the SOH indicated by a charge capacity. The battery processor 42 may manage various kinds of degradation degrees of the battery 4, such as a degradation degree indicated by internal resistance, a degradation degree indicated by charge/discharge efficiency, or a degradation degree indicated by a maximum current.

The battery processor 42 may further manage chargeable power Win and dischargeable power Wout of the battery 4. The chargeable power Win and the dischargeable power Wout may each vary depending on the state amount of the battery 4, such as the charge remains or temperature of the battery 4. The battery processor 42 may hold a data table indicating correspondence between the state amount of the battery 4 and the chargeable power Win and correspondence between the state amount of the battery 4 and the dischargeable power Wout, and calculate the chargeable power Win and the dischargeable power Wout referring to the data table.

The vehicle processor 41 may control the power running operation of the travel motor 3 through communication with the battery processor 42 without causing electric power greater than or equal to the dischargeable power Wout to be discharged from the battery 4. The vehicle processor 41 may control the regenerative operation of the travel motor 3 through the communication with the battery processor 42 without causing electric power greater than or equal to the chargeable power Win to be transmitted to the battery 4.

### Normal Mode and Boost Mode

The vehicle processor 41 may be configured to switch a control mode of the electric vehicle 1 between a normal mode and the boost mode. The term “normal mode” used herein may refer to a control mode that controls driving of the travel motor 3 at an output less than or equal to a normal output upper limit of the travel motor 3 (i.e., in a manner that an output of the battery 4 is less than or equal to an output upper limit of the battery 4). The term “boost mode” used herein may refer to a control mode that raises the output upper limit of the travel motor 3 (i.e., the output upper limit of the battery 4) temporarily, for example, for three seconds to eight minutes. The output upper limits in the normal mode may be each set to such a predetermined value that prevents the battery 4 from degrading greatly. The output upper limits in the boost mode may be each set to such a predetermined value that degrades the battery 4 faster than in the normal mode but, by being temporarily raised (when temporal control of the boost mode is performed), ensures normal operations of components of a travel system, such as the travel motor 3, the battery 4, and the inverter 5.

In some embodiments where the battery 4 has high dischargeable power Wout, the boost mode may be a control mode that allows the driving force to be outputted to reach each of the temporarily raised output upper limits. In some embodiments where the battery 4 is in various other states, the boost mode may be a control mode that causes the dischargeable power Wout calculated based on the state of the battery 4 to be temporarily increased to, for example, 120%.

### Expected Change Amount of Degradation Degree Generated in Single Time of Boost Mode

The battery 4 may typically degrade more greatly when the electric vehicle 1 is traveling with the boost mode being activated than when the electric vehicle 1 is traveling in the normal mode. Even when the boost mode is activated, however, the battery 4 may not degrade much if the driver refrains from performing a large accelerator operation. Further, even when the same accelerator operation is performed, a change amount of the degradation degree may vary depending on environmental conditions such as an ambient temperature and the state of the battery 4 such as the SOC or temperature of the battery 4.

The vehicle processor 41 may hold in advance data on an expected change amount of the degradation degree of the battery 4 subjected to the boost mode that produces a large output. In some embodiments, the expected change amount may be a change amount to be estimated when the battery 4 degrades in the largest degree. In other words, the expected change amount may be a change amount of the degradation degree to be estimated when a maximum accelerator operation is performed and when the battery 4 is placed under an environmental condition that promotes the degradation of the battery 4 in the largest degree and in a state that facilitates the degradation of the battery 4 in the largest degree. Adoption of such an expected change amount allows the degradation degree to be fixed to a change range from 0% to 100% displayed in the form of a gauge indication 82 to be described later. This helps to provide the simple gauge indication 82 that allows the driver to easily grasp a change speed on the gauge indication 82.

Note that the expected change amount of the degradation degree held in the vehicle processor 41 is not limited to the above example. In some embodiments, the expected change amount may be a change amount of the degradation degree to be estimated when a driving operation is performed in the boost mode at an average output which may be 90% or 80% of a maximum output, for example. In some embodiments, a data table or calculation expression of the expected change amount corresponding to the environmental condition and the state of the battery 4 may be provided to the vehicle processor 41 in advance. In this case, the vehicle processor 41 may calculate the expected change amount of the degradation degree, based on the environmental condition and the state of the battery 4 using the data table or the calculation expression.

### Assumed Degradation Degree of Battery 4

An assumed degradation degree of the battery 4 of the electric vehicle 1 may be set in advance. The term “assumed degradation degree” used herein may refer to a degradation degree planned in advance by a company such as a manufacturer or a dealership. The battery 4 may degrade with use or over time even if no charging/discharging is performed. Accordingly, the assumed degradation degree may be determined and planned based on a travel distance and a measured time of the electric vehicle 1. In some embodiments, the assumed degradation degree may be determined and planned based on the travel distance of the electric vehicle 1 or the measured time of the electric vehicle 1. Data based on which the assumed degradation degree is to be acquired may be stored in a storage 41a of the vehicle processor 41. The data may include, without limitation, a calculation expression or data table usable for calculating the assumed degradation degree planned as described above. The vehicle processor 41 may be configured to acquire the assumed degradation degree of the battery 4, based on the above-described data as well as one or both of the measured time of the electric vehicle 1 and the travel distance of the electric vehicle 1. Such setting of the assumed degradation degree helps the user to grasp a time period and a travel distance over which the battery 4 is continuously usable.

### Boost Mode Control Processing

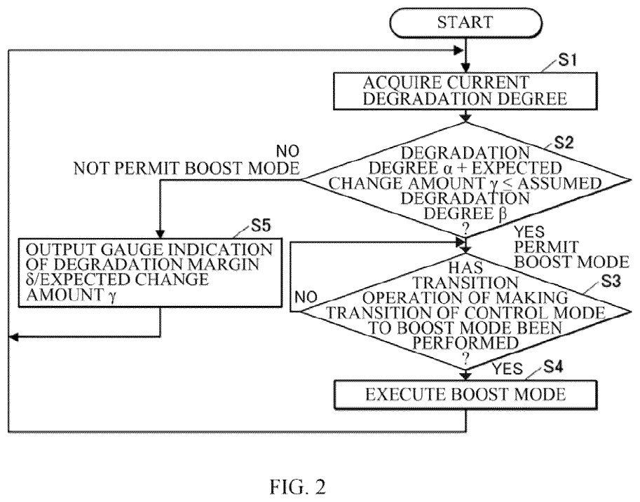

FIG. 2 is a flowchart illustrating boost mode control processing executed by the vehicle processor 41.

The vehicle processor 41 may repeatedly execute the boost mode control processing during an operation of the electric vehicle 1. In the boost mode control processing, the vehicle processor 41 may first acquire the degradation degree at a current time point of the battery 4 from the battery processor 42 (step S1). The battery processor 42 may measure or estimate the degradation degree of the battery 4 at each time point by the above-described method.

Thereafter, the vehicle processor 41 may determine whether to permit the boost mode, based on a degradation state amount of the battery 4 (step S2). The degradation state amount may correspond to an absolute or relative amount that indicates the degradation state of the battery 4. Non-limiting examples of the degradation state amount may include: the degradation degree of the battery 4; a difference between the degradation degree of the battery 4 and the assumed degradation degree of the battery 4; and a comparison amount resulting from comparing the difference with the expected change amount of the degradation degree of the battery 4 to be generated in a single time of the boost mode. The determination based on the degradation state amount enables control of the boost mode in which the boost mode is not permitted when the battery 4 has degraded greatly, whereas the boost mode is permitted when the battery 4 has not degraded much. Such control helps to achieve the boost mode that appropriately balances two aims of securing a lifetime of the battery 4 and satisfying a preference of the driver.

In some embodiments, in step S2, the vehicle processor 41 may determine whether to permit the boost mode, based on the difference between the degradation degree at the current time point of the battery 4 and the assumed degradation degree assumed in advance for the electric vehicle 1. Such control helps to restrain the degradation degree of the battery 4 from deviating greatly from the assumed degradation degree due to the boost mode.

In some embodiments, in step S2, the vehicle processor 41 may determine whether to permit the boost mode by performing comparison among a degradation degree α at the current time point of the battery 4, an assumed degradation degree β of the battery 4, and an expected change amount γ of the degradation degree of the battery 4 to be generated in the boost mode. In some embodiments, α+γ≤β may be set as a permission condition. Such a permission condition allows the boost mode to be activated without causing the degradation degree of the battery 4 to exceed the assumed degradation degree.

If the boost mode has been permitted in step S2 (step S2: YES), the vehicle processor 41 may determine whether a transition operation has been performed of making the transition of the control mode to the boost mode (step S3). If the transition operation has not been performed (step S3: NO), the vehicle processor 41 may repeat the process of step S3 until the transition operation is performed.

If the transition operation has been performed in step S3 (step S3: YES), the vehicle processor 41 may switch the control mode to the boost mode and execute the temporal control of the boost mode (step S4). Thereafter, when the boost mode has been completed and the control mode has returned to the normal mode, the vehicle processor 41 may cause the processing to return to step S1.

If the boost mode is determined not to be permitted in step S2 (step S2: NO), the vehicle processor 41 may output, to the display 8, displaying 80 including the gauge indication 82 indicating how much change in the degradation state amount of the battery 4 is necessary to permit the boost mode (step S5). Thereafter, the vehicle processor 41 may cause the processing to return to step S1.

While the boost mode is not permitted, the vehicle processor 41 may provide the gauge indication 82 reflecting the degradation degree at each time point of the battery 4, by repeating loop processing of steps S1, S2, and S5.

### Gauge Indication

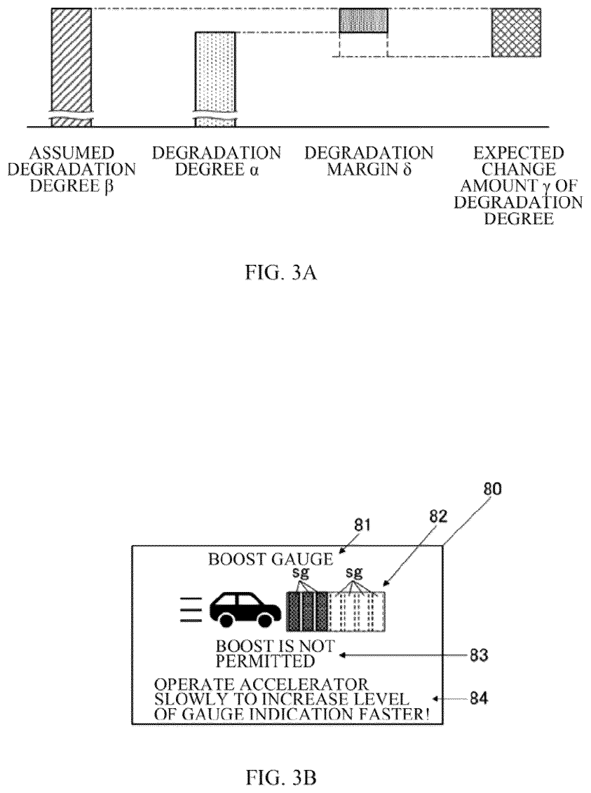

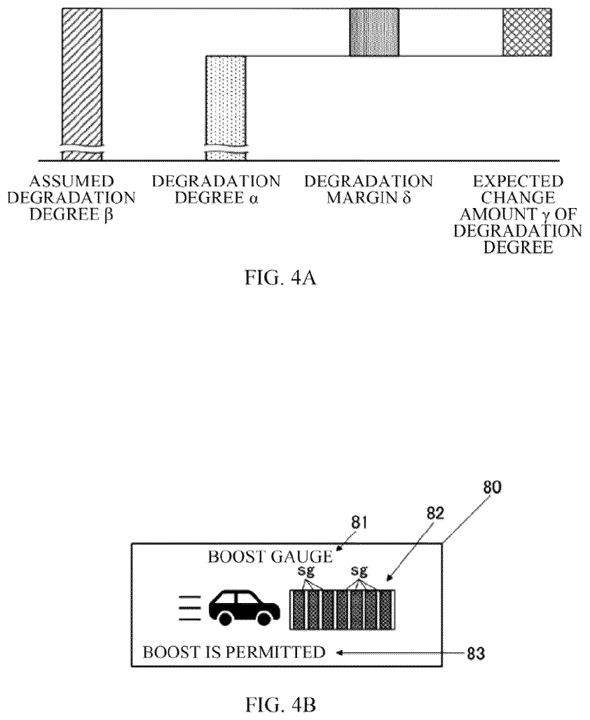

FIGS. 3A and 4A are each an explanatory graph of the degradation state amount of the battery 4 calculated to determine whether to permit the boost mode. FIGS. 3B and 4B illustrate respective exemplary images displayed on the display 8 in the cases of the respective degradation states of FIGS. 3A and 4A.

Referring to FIGS. 3B and 4B, the displaying 80 outputted in step S5 may include the gauge indication 82 indicating how soon the boost mode is to become activatable. The displaying 80 may further include a title indication 81 and a permission information indication 83. As illustrated in FIGS. 3B and 4B, the gauge indication 82 may indicate a level of a gauge amount by the number of display segments sg turned on, out of multiple display segments sg. In some embodiments, the gauge indication 82 may indicate this level by a percentage or any other numerical value.

As illustrated in FIG. 3B, when making the transition of the control mode to the boost mode is not permitted, the displaying 80 may include an information indication 84 indicating a travel method that allows faster transition of the control mode to the boost mode. In some embodiments, various pieces of information indicating a travel method that slows down the degradation of the battery 4 may be stored in advance in the vehicle processor 41, and the information indication 84 may be provided by selecting and outputting an appropriate piece of information out of the various pieces of information by the vehicle processor 41.

As illustrated in the respective graphs of FIGS. 3A and 4A, the gauge amount represented as the gauge indication 82 indicates a proportion of a degradation margin δ at the current time point of the battery 4 to the expected change amount γ of the degradation degree of the battery 4 to be generated in the single time of the boost mode. The term “degradation margin δ” used herein may refer to an amount resulting from subtracting the degradation degree α at the current time point from the assumed degradation degree β at the current time point.

The gauge indication 82 on such displaying 80 may have the level that increases as the degradation margin δ increases during traveling in the normal mode. This allows the driver to grasp how soon the degradation margin δ is to reach the expected change amount γ of the degradation degree to be generated in the single time of the boost mode, i.e., how soon the boost mode is to become activatable. At this time, the information indication 84 may notify the driver of a driving operation that allows fast transition of the control mode to the boost mode. When the gauge indication 82 indicates a gauge amount of 100% as illustrated in FIG. 4B, the driver may be notified that the boost mode is activatable.

### Other Examples of Gauge Indication 82 and Permission Condition of Boost Mode

Note that the permission condition of the boost mode is not limited to the above-described example. In some embodiments, α+γ≤β+ε may be set as the permission condition, where ε denotes a predetermined tolerance. The tolerance ε may be a positive value or a negative value. Such a permission condition allows the boost mode to be activated without causing the degradation degree α of the battery 4 to increase from the assumed degradation degree β of the battery 4 beyond a range of the tolerance ε. In this case, provided that β+ε−α is defined as a gauge target amount, a proportion may be calculated of the gauge target amount to the expected change amount γ of the battery 4 to be generated in the single time of the boost mode, and the proportion may be indicated in the form of the gauge indication 82. Such a permission condition and gauge indication 82 also allow the driver to grasp the boost mode similarly to the permission condition and gauge indication 82 described above.

In some embodiments, the vehicle processor 41 may set α≤β as the permission condition of the boost mode. Such a permission condition allows the boost mode to be activated without causing the degradation degree α of the battery 4 to increase from the assumed degradation degree β beyond a range of the expected change amount γ of the degradation degree to be generated in the single time of the boost mode. In this case, provided that β−α+γ is defined as the gauge target amount, a proportion may be calculated of the gauge target amount to the expected change amount γ to be generated in the single time of the boost mode, and the proportion may be indicated on the gauge indication 82. Such a permission condition and gauge indication 82 also allow the driver to grasp the boost mode similarly to the permission condition and gauge indication 82 described above.

Although the proportion of the gauge target amount to the expected change amount γ to be generated in the single time of the boost mode is indicated in the form of the gauge indication 82 in the above-described examples, an equivalent constant γ2 may be used in place of the above-described expected change amount γ. When the constant γ2 of an appropriate value is used, the gauge indication 82 may indicate a proportion of the gauge target amount to the constant γ2. Such a gauge indication 82 helps the driver to grasp how soon the boost mode is to be permitted after the boost mode has once been determined not to be permitted.

A program of the boost mode control processing described above may be stored in a non-transitory computer-readable recording medium such as the storage 41a of the vehicle processor 41. The vehicle processor 41 may be configured to read the program stored in a portable non-transitory recording medium and execute the program. The portable non-transitory recording medium may hold the program of the boost mode control processing.

Although the disclosure has been described hereinabove in terms of the example embodiment, the disclosure is not limited thereto. For example, in the foregoing example embodiment, the vehicle processor 41 may calculate the assumed degradation degree; however, this is a non-limiting example. In some embodiments, the battery processor 42 may be configured to calculate the assumed degradation degree. Further, in the foregoing example embodiment, the vehicle processor 41 may be configured to hold or calculate the expected change amount of the degradation degree to be generated in the boost mode; however, this is a non-limiting example. In some embodiments, the battery processor 42 may be configured to hold or calculate the expected change amount. Furthermore, in the foregoing example embodiment, the electric vehicle 1 may not include an internal combustion engine; however, this is a non-limiting example. In some embodiments, the electric vehicle 1 may include an internal combustion engine.

It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a”, “an”, and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

According to at least one embodiment of the disclosure, it is possible to provide a boost mode operation that is highly usable by a driver who drives an electric vehicle.

Each of the vehicle processor 41 and the battery processor 42 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of each of the vehicle processor 41 and the battery processor 42. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of each of the vehicle processor 41 and the battery processor 42 illustrated in FIG. 1.

1. A processing apparatus to be applied to an electric vehicle, the electric vehicle comprising a travel motor configured to drive a drive wheel, a battery configured to store electric power usable for traveling of the electric vehicle, a boost operation member configured to be operated by a driver who drives the electric vehicle, and a display to be disposed in a driver's cabin of the electric vehicle, the processing apparatus comprising:
a vehicle processor configured to control driving of the travel motor to cause an output of the battery to become less than or equal to an output upper limit of the battery; and
a battery processor configured to monitor a state of the battery, wherein
the vehicle processor is configured to operate in a control mode comprising a boost mode, the boost mode being configured to temporarily raise the output upper limit in response to an operation of the boost operation member,
the vehicle processor is configured to
determine whether to permit the boost mode, based on a degradation state amount of the battery, and
output a gauge indication to the display when the boost mode is determined not to be permitted based on the degradation state amount, the gauge indication indicating how much change in the degradation state amount is necessary to permit the boost mode, and
the degradation state amount comprises a difference between an assumed degradation degree planned in advance and a degradation degree of the battery estimated by the battery processor.

2. A processing apparatus to be applied to an electric vehicle, the electric vehicle comprising a travel motor configured to drive a drive wheel, a battery configured to store electric power usable for traveling of the electric vehicle, a boost operation member configured to be operated by a driver who drives the electric vehicle, and a display to be disposed in a driver's cabin of the electric vehicle, the processing apparatus comprising:
a vehicle processor configured to control driving of the travel motor to cause an output of the battery to become less than or equal to an output upper limit of the battery; and
a battery processor configured to monitor a state of the battery, wherein
the vehicle processor is configured to operate in a control mode comprising a boost mode, the boost mode being designed to temporarily raise the output upper limit in response to an operation of the boost operation member, and
the vehicle processor is configured to
determine whether to permit the boost mode, based on a degradation state amount of the battery,
output a gauge indication to the display when the boost mode is determined not to be permitted based on the degradation state amount, the gauge indication indicating how much change in the degradation state amount is necessary to permit the boost mode, and
further output an information indication to the display when the boost mode is determined not to be permitted based on the degradation state amount, the information indication indicating a travel method that allows faster transition of the control mode to the boost mode.

3. The processing apparatus according to claim 1, further comprising
a storage configured to hold data based on which the assumed degradation degree is to be acquired, wherein
the data indicates a relationship between: the assumed degradation degree; and one or both of an age of the battery and a travel distance of the electric vehicle.

4. The processing apparatus according to claim 1, wherein the vehicle processor is configured to determine whether to permit the boost mode by comparing the difference between the assumed degradation degree and the degradation degree with an expected change amount of the degradation degree to be generated in the battery in a single time of the boost mode.
